(19) United States
(12) Patent Application Publication
(10) Pub. No.: US 2017/0128984 A1
(43) Pub. Date: May 11, 2017

(54) APPARATUS AND METHOD FOR A REMOVABLE SCREENING PLATE ASSEMBLY

(71) Applicant: Kolberg-Pioneer, Inc., Yankton, SD (US)

(72) Inventor: Robert H. Frohreich, Yankton, SD (US)

(21) Appl. No.: 15/342,796

(22) Filed: Nov. 3, 2016

Related U.S. Application Data
(60) Provisional application No. 62/252,072, filed on Nov. 6, 2015.

(51) Int. Cl. B07B 1/46; B07B 1/12

(52) U.S. Cl. CPC B07B 1/4645; B07B 1/469; B07B 1/12

(57) ABSTRACT

A screening plate assembly adapted for use on an item of equipment and comprising a mounting assembly adapted to be mounted on the item of equipment and a screening plate adapted to be attached to the mounting assembly. Preferably, the screening plate is removably attached to the mounting assembly. A method for removably attaching a screening plate assembly to an item of equipment comprising providing a screening plate assembly, mounting the mounting assembly on the item of equipment, and removably attaching the screening plate to the mounting assembly.

### CROSS-REFERENCES TO RELATED APPLICATIONS/PATENTS

This application relates back to and claims the benefit of priority from U.S. Provisional Application for Patent Ser. No. 62/252,072 titled “Grizzly Plate” and filed on Nov. 6, 2015.

### FIELD OF THE INVENTION

The present invention relates generally to apparatuses and methods for screening materials, and particularly to apparatuses and methods for screening plates.

### BACKGROUND AND DESCRIPTION OF THE PRIOR ART

It is known to use apparatuses and methods to screen materials prior to crushing activities. Conventional apparatuses and methods for screening materials, however, suffer from one or more disadvantages. For example, some conventional screening apparatuses are welded to the item of equipment with which they are used. As a result, such conventional screening apparatuses and methods do not allow for easy removal and replacement. Other conventional screening apparatuses are attached to the item of equipment with which they are used with a complex support structure. These conventional screening apparatuses are similarly difficult to remove and replace. Conventional screening apparatuses are also undesirably expensive.

It would be desirable, therefore, if an apparatus and method for a screening plate could be provided that would not be welded to the item of equipment with which it is used. It would also be desirable if such an apparatus and method for a screening plate could be provided that would not be attached to the item of equipment with which it is used with a complex support structure. It would be further desirable if such an apparatus and method for a screening plate could be provided that would not be undesirably expensive.

### Advantages of the Preferred Embodiments of the Invention

Accordingly, it is an advantage of the preferred embodiments of the invention claimed herein to provide an apparatus and method for a screening plate that is easily removed from and replaced on the item of equipment with which it is used. It is also an advantage of the preferred embodiments of the invention claimed herein to provide an apparatus and method for a screening plate that is desirably inexpensive.

Additional advantages of the preferred embodiments of the invention will become apparent from an examination of the drawings and the ensuing description.

### SUMMARY OF THE INVENTION

The apparatus of the invention comprises a screening plate assembly adapted for use on an item of equipment. The preferred screening plate assembly comprises a mounting assembly that is adapted to be mounted on the item of equipment and a screening plate that is adapted to be attached to the mounting assembly. Preferably, the screening plate is removably attached to the mounting assembly.

The method of the invention comprises a method for removably attaching a screening plate assembly to an item of equipment. The preferred method comprises providing a screening plate assembly. The preferred screening plate assembly comprises a mounting assembly that is adapted to be mounted on the item of equipment and a screening plate that is adapted to be attached to the mounting assembly. Preferably, the screening plate is removably attached to the mounting assembly. The preferred method also comprises mounting the mounting assembly on the item of equipment and removably attaching the screening plate to the mounting assembly.

### BRIEF DESCRIPTION OF THE DRAWINGS

The presently preferred embodiments of the invention are illustrated in the accompanying drawings, in which like reference numerals represent like parts throughout, and in which:

FIG. 1 is a perspective front view of the preferred embodiment of the screening plate assembly in accordance with the present invention.

FIG. 2 is a right side view of the preferred screening plate assembly illustrated in FIG. 1.

FIG. 3 is a top view of the preferred screening plate assembly illustrated in FIGS. 1-2.

FIG. 4 is a bottom view of the preferred screening plate assembly illustrated in FIGS. 1-3.

FIG. 5 is a back view of the preferred screening plate assembly illustrated in FIGS. 1-4.

FIG. 6 is a front view of the preferred screening plate assembly illustrated in FIGS. 1-5.

FIG. 7 is a front perspective view of the preferred screening plate assembly illustrated in FIGS. 1-6 shown with exemplary support weldments.

FIG. 8 is a front perspective view of the preferred screening plate assembly illustrated in FIGS. 1-7 shown on an exemplary screening unit.

FIG. 9 is a front perspective view of a first alternative embodiment of the screening plate assembly in accordance with the present invention.

### DESCRIPTION OF THE PREFERRED EMBODIMENTS OF THE INVENTION

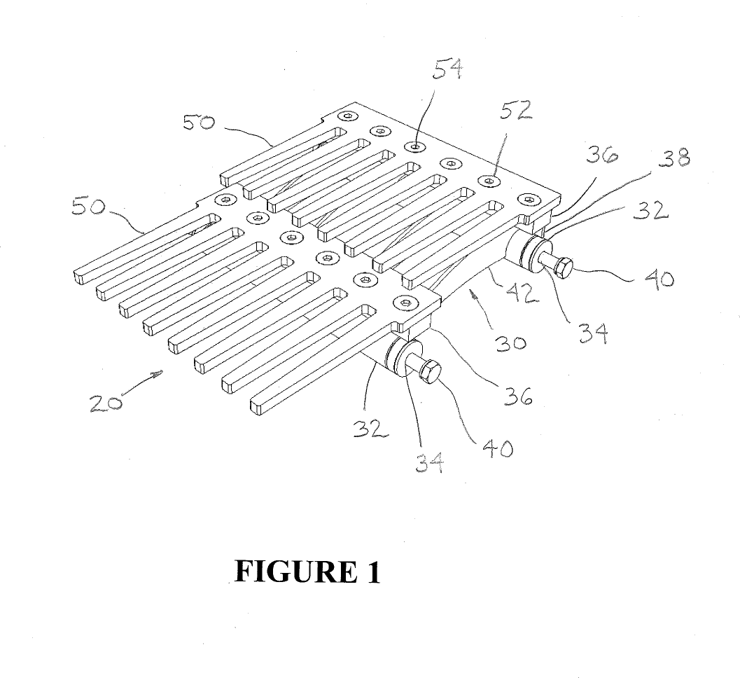

Referring now to the drawings, the preferred embodiments of the screening plate in accordance with the present invention are illustrated by FIGS. 1 through 9. As shown in FIGS. 1-9, the preferred screening plates are adapted to be easily removed from and replaced on the item of equipment with which they are used. As a result, worn or damaged plates are more easily removed for repair or replacement with new plates. The preferred screening plates are also more easily and removed and replaced with different types of plates in the event a different type of screening is desired.

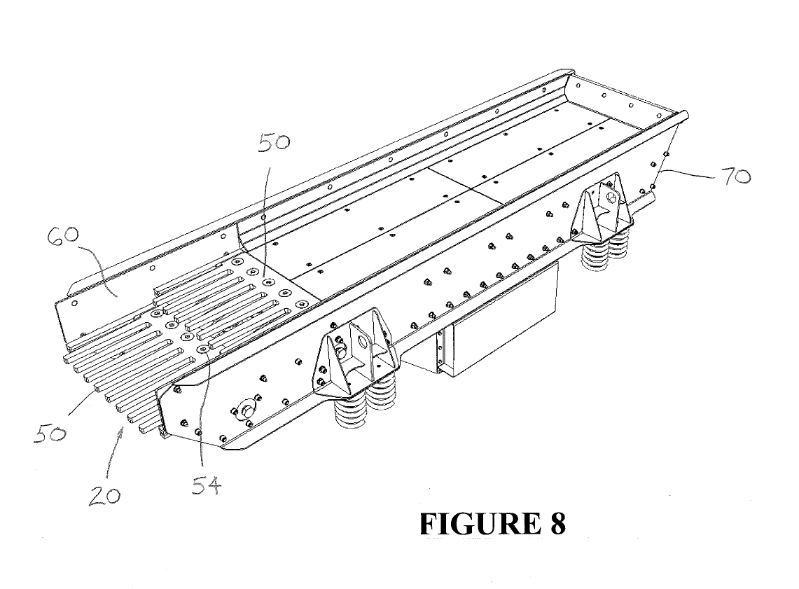

Referring now to FIG. 1, a perspective front view of the preferred embodiment of the screening plate in accordance with the present invention is illustrated. As shown in FIG. 1, the preferred screening plate assembly is designated generally by reference numeral 20. Preferred screening plate assembly 20 is adapted for use on an item of equipment such as a screen assembly (see FIG. 8). Preferred screen assembly 20 comprises mounting assembly 30 which is adapted to be mounted on the item of equipment, and preferably removably mounted on the item of equipment.

Preferred mounting assembly 30 comprises one or more support structures 32, each of which is adapted to be removably mounted on the item of equipment and each of which has at least one support structure hole 34. Preferred mounting assembly 30 also comprises one or more mounting blocks 36, each of which has at least one mounting block hole. Preferred mounting assembly 30 further comprises seal plate 38 which is adapted to prevent materials from falling out of the back of the grizzly area. Preferred mounting assembly 30 still further comprises one or more mounting assembly threaded fasteners 40. In addition, preferred mounting assembly 30 comprises one or more braces 42 which extend between a pair of support structures 32.

Still referring to FIG. 1, preferred screening plate assembly 20 also comprises one or more screening plates 50 which are adapted to be attached to mounting assembly 30. Preferably, screening plates 50 are removably attached to mounting assembly 30. Each preferred screening plate 50 comprises one or more screening plate holes 52 and one or more screening plate threaded fasteners 54. While FIG. 1 illustrates the preferred configuration and arrangement of the screening plate assembly in accordance with the present invention, it is contemplated within the scope of the invention that the screening plate assembly may be of any suitable configuration and arrangement. It is also contemplated within the scope of the invention that the screening plate assembly may comprise fewer than or more than two screening plates and fewer than or more than two support structures.

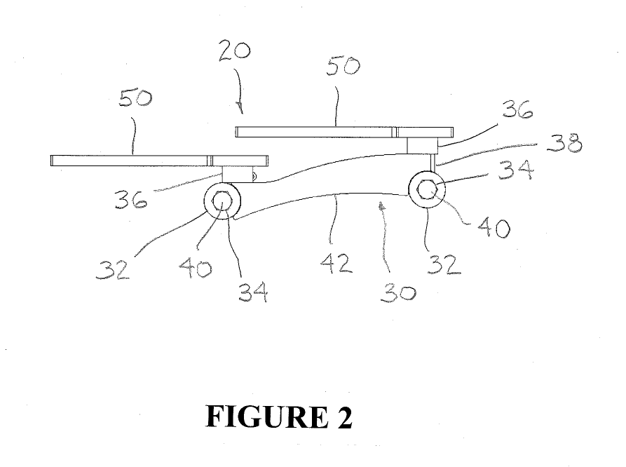

Referring now to FIG. 2, a right side view of the preferred screening plate assembly 20 is illustrated. As shown in FIG. 2, preferred screening plate assembly 20 comprises mounting assembly 30, support structures 32, support structure holes 34, mounting blocks 36, seal plate 38, mounting assembly threaded fasteners 40, brace 42, and screening plates 50.

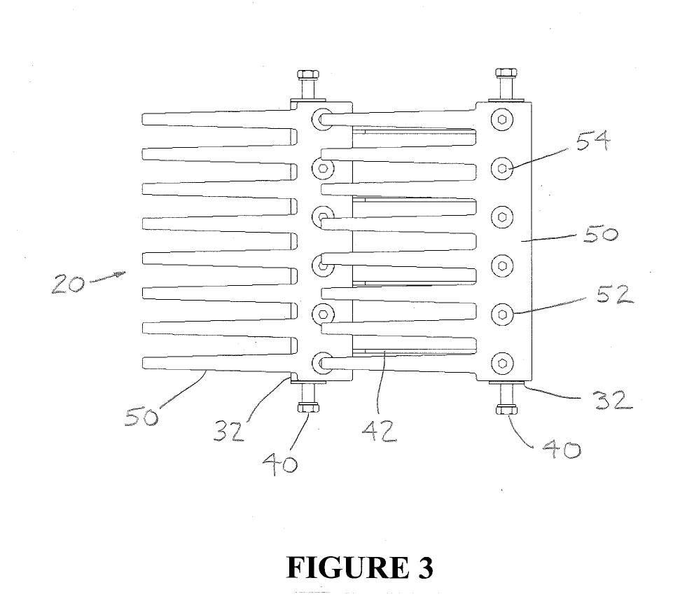

Referring now to FIG. 3, a top view of preferred screening plate assembly 20 is illustrated. As shown in FIG. 3, preferred screening plate assembly 20 comprises support structures 32, mounting assembly threaded fasteners 40, braces 42, screening plates 50, screening plate holes 52, and screening plate threaded fasteners 54.

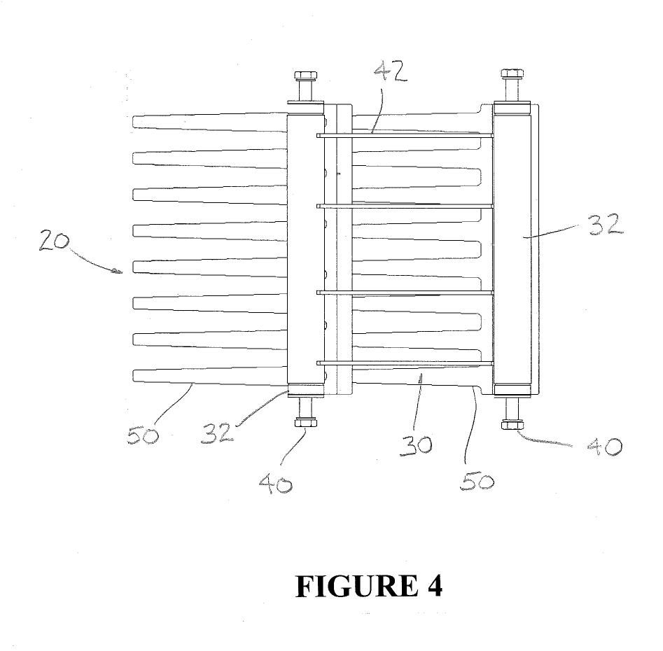

Referring now to FIG. 4, a bottom view of preferred screening plate assembly 20 is illustrated. As shown in FIG. 4, preferred screening plate assembly 20 comprises mounting assembly 30, support structures 32, mounting assembly threaded fasteners 40, braces 42, and screening plates 50.

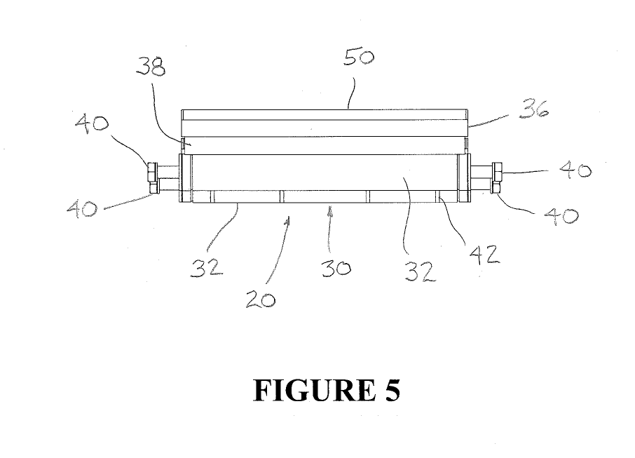

Referring now to FIG. 5, a back view of preferred screening plate assembly 20 is illustrated. As shown in FIG. 5, preferred screening plate assembly 20 comprises mounting assembly 30, support structures 32, mounting block 36, seal plate 38, mounting assembly threaded fasteners 40, and braces 42.

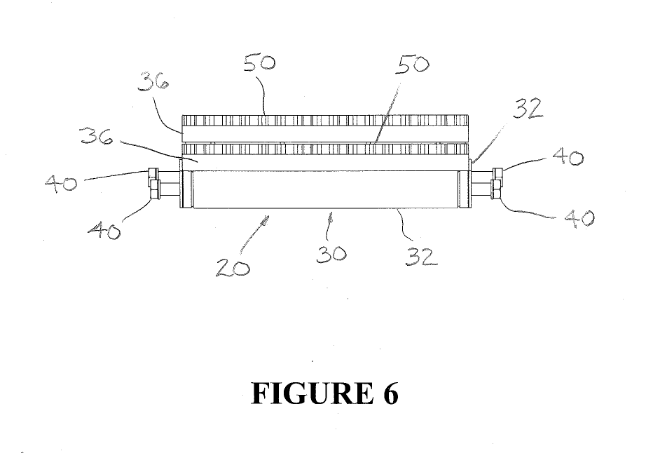

Referring now to FIG. 6, a front view of preferred screening plate assembly 20 is illustrated. As shown in FIG. 6, preferred screening plate assembly 20 comprises mounting assembly 30, support structures 32, mounting blocks 36, mounting assembly threaded fasteners 40, and screening plates 50.

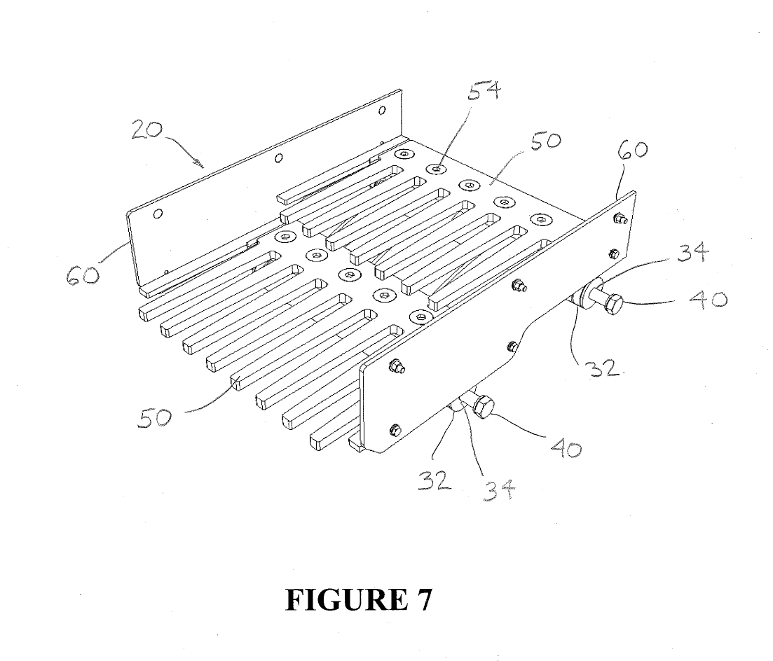

Referring now to FIG. 7, a front perspective view of preferred screening plate assembly 20 is illustrated with exemplary support weldments. As shown in FIG. 7, preferred screening plate assembly 20 comprises support structures 32, support structure holes 34, mounting assembly threaded fasteners 40, screening plates 50, screening plate threaded fasteners 54, and weldments 60.

Referring now to FIG. 8, a front perspective view of preferred screening plate assembly 20 is illustrated on exemplary screening unit 70. As shown in FIG. 8, preferred screening plate assembly 20 comprises screening plates 50, screening plate threaded fasteners 54, and weldments 60. While FIG. 8 illustrates preferred screening plate assembly 20 removably mounted on a screening unit, it is contemplated within the scope of the invention that the screening plate assembly may be removably mounted to any suitable item of equipment including without limitation material handling equipment such as conveyors, feed systems, and the like and washing and classifying equipment such as washers, classifying tanks, and the like.

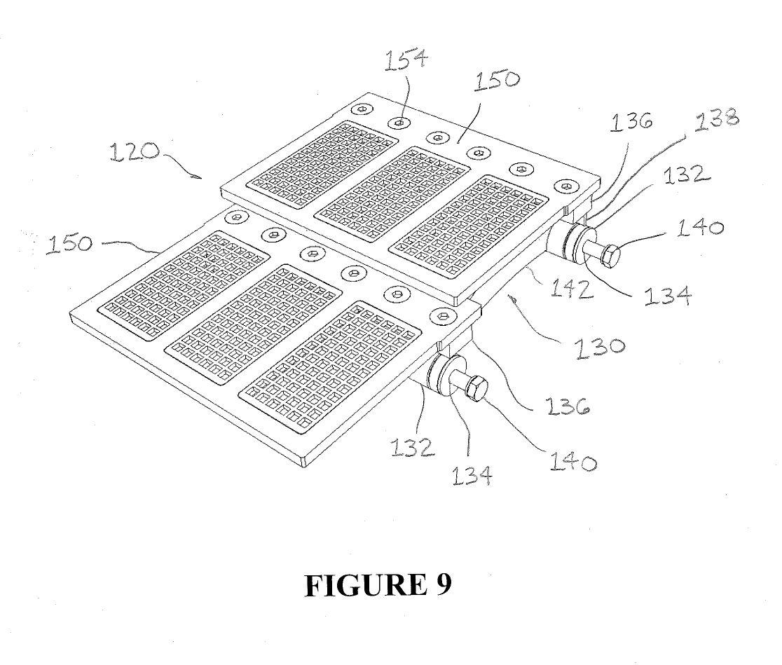

Referring now to FIG. 9, a front perspective view of a first alternative embodiment of the screening plate assembly in accordance with the present invention is illustrated. As shown in FIG. 9, the first alternative embodiment of the screening plate assembly is designated generally by reference numeral 120. Preferred screening plate assembly 120 comprises mounting assembly 130, support structures 132, support structure holes 134, mounting blocks 136, seal plate 138, mounting assembly threaded fasteners 140, brace 142, screening plates 150, and screening plate threaded fasteners 154. Preferred screening plates 150 are adapted to prevent certain materials from passing through them which would pass through screening plates 50 illustrated in FIGS. 1-8. While FIG. 9 illustrates a preferred configuration and arrangement of the screening plates, it is contemplated within the scope of the invention that the screening plates may be of any suitable configuration and arrangement.

The invention also comprises a method for removably attaching a screening plate assembly to an item of equipment. The preferred method comprises providing a screening plate assembly. The preferred screening plate assembly comprises a mounting assembly that is adapted to be mounted on the item of equipment and a screening plate that is adapted to be attached to the mounting assembly. Preferably, the screening plate is removably attached to the mounting assembly. The preferred method further comprises mounting the mounting assembly on the item of equipment and removably attaching the screening plate to the mounting assembly. In other preferred embodiments of the method of the invention, the screening plate assembly comprises a mounting assembly having a support structure with a support structure hole and a mounting block with a mounting block hole. In still other preferred embodiments of the method of the invention, the screening plate assembly comprises a screening plate having a screening plate hole.

In operation, several advantages of the preferred embodiments of the screening plate assembly are achieved. For example, the preferred embodiments of the screening plate assembly allow for screening plates to be easily removed from and replaced on an item of equipment. As a result, maintenance and repairs may be performed less expensively. In addition, different-sized screening plates may be used with greater ease, less expense, and less equipment down-time.

Although this description contains many specifics, these should not be construed as limiting the scope of the invention but as merely providing illustrations of some of the presently preferred embodiments thereof, as well as the best mode contemplated by the inventors of carrying out the invention. The invention, as described herein, is susceptible to various modifications and adaptations, and the same are intended to be comprehended within the meaning and range of equivalents of the appended claims.

What is claimed is:

1. A screening plate assembly adapted for use on an item of equipment, said screening plate assembly comprising:
(a) a mounting assembly, said mounting assembly being adapted to be mounted on the item of equipment;
(b) a screening plate, said screening plate being adapted to be attached to the mounting assembly,
wherein the screening plate is removably attached to the mounting assembly.

2. The screening plate assembly of claim 1 wherein the mounting assembly is adapted to be removably mounted on the item of equipment.

3. The screening plate assembly of claim 1 wherein the mounting assembly comprises a support structure.

4. The screening plate assembly of claim 3 wherein the support structure is adapted to be removably mounted on the item of equipment.

5. The screening plate assembly of claim 3 wherein the support structure comprises a support structure hole.

6. The screening plate assembly of claim 1 wherein the mounting assembly comprises a mounting block.

7. The screening plate assembly of claim 6 wherein the mounting block comprises a mounting block hole.

8. The screening plate assembly of claim 1 wherein the screening plate comprises a screening plate hole.

9. The screening plate assembly of claim 1 further comprising a screening plate threaded fastener.

10. The screening plate assembly of claim 1 wherein the mounting assembly comprises a plurality of support structures.

11. The screening plate assembly of claim 10 wherein each of the plurality of support structures is adapted to be removably mounted on the item of equipment.

12. The screening plate assembly of claim 10 wherein each of the plurality of support structures comprises a support structure hole.

13. The screening plate assembly of claim 10 further comprising a brace extending between the plurality of support structures.

14. The screening plate assembly of claim 10 further comprising a plurality of braces extending between the plurality of support structures.

15. The screening plate assembly of claim 1 wherein the mounting assembly comprises a plurality of mounting blocks.

16. The screening plate assembly of claim 15 wherein each of the plurality of mounting blocks comprises a mounting block hole.

17. The screening plate assembly of claim 1 comprising a plurality of screening plates.

18. The screening plate assembly of claim 17 wherein each of the plurality of screening plates comprises a screening plate hole.

19. A method for removably attaching a screening plate assembly to an item of equipment, said method comprising:
(a) providing a screening plate assembly, said screening plate assembly comprising:
(i) a mounting assembly, said mounting assembly being adapted to be mounted on the item of equipment;
(ii) a screening plate, said screening plate being adapted to be attached to the mounting assembly,
wherein the screening plate is removably attached to the mounting assembly;
(b) mounting the mounting assembly on the item of equipment; and
(c) removably attaching the screening plate to the mounting assembly.

20. The method of claim 19 wherein the screening plate assembly comprises (i) a mounting assembly having a support structure with a support structure hole and a mounting block with a mounting block hole and (ii) a screening plate having a screening plate hole.
